(19) United States
(12) Patent Application Publication
(10) Pub. No.: US 2017/0353747 A1
(43) Pub. Date: Dec. 7, 2017

(54) Quality of Media Synchronization

(71) Applicants: Koninklijke KPN N.V., The Hague (NL); Nederlandse Organisatie Voor Toegepast- Natuurwetenschappelijk Onderzoek TNO, s-Gravenhage (NL)

(72) Inventors: Emmanuel Thomas, Delft (NL); Martin Prins, The Hague (NL); Hans Maarten Stokking, Wateringen (NL); Omar Aziz Niamut, Vlaardingen (NL)

(21) Appl. No.: 15/538,178

(22) PCT Filed: Dec. 14, 2015
(86) PCT No.: PCT/EP2015/079590

§ 371 Date: Jun. 20, 2017

(30) Foreign Application Priority Data
Dec. 22, 2014 (EP) 14199743.7

(51) Int. Cl. H04N 21/242; H04N 21/4788; H04N 21/2387; H04N 21/8547; H04N 21/234

(52) U.S. Cl. CPC H04N 21/242; H04N 21/8547; H04N 21/23418; H04N 21/2387; H04N 21/4788

(57) ABSTRACT

The play-out of a media stream by a play-out device may be synchronized by a synchronization subsystem with a reference play-out, thereby obtaining a degree of synchronicity with the reference play-out. To address a structural deficiency in the obtaining of the synchronicity with the reference play-out, the play-out device may report a quality of sync metric to a metric subsystem, which may then be analysed to identify the structural deficiency. A corrective action may then be scheduled to address the structural deficiency. Examples of corrective actions include re-clustering of play-out devices, adjusting priority and/or bandwidth in the streaming, etc. As such, the quality of experience of one or more users experiencing the play-out may be improved.

### FIELD OF THE INVENTION

The invention relates to a system and method for media synchronization. The invention further relates to a play-out device for use in the system and to data representing a reporting of the play-out device. The invention further relates to a computer program product for causing a processor system to perform the method.

### BACKGROUND ART

Media content such as video content and audio content is commonly delivered to users in a digital form. If media content has a temporal aspect, and in particular is associated with a timeline which indicates how the media content is to be played out or otherwise processed over time, such digital form is typically referred to as a media stream. Examples of media streams include video streams such as camera-recorded or computer-rendered streams, audio streams such as microphone-recorded streams, timed text streams such as subtitle streams or social-media streams, timed events streams which show an advertisement image or perform an action at a receiver, and multimedia streams comprising different types of media streams.

There may be a need to synchronize the play-out of a media stream to a reference play-out. For example, a group of soccer fans may be located at different locations but may like to watch together a soccer match by streaming the match online from one or more media servers. During the soccer match, the soccer fans may then communicate with each other, e.g., using chat or voice services. In such a case, it may be noticeable and even detrimental to the shared experience of the soccer match if the play-out at the different locations is asynchronous. Namely, a user of which the play-out is running ahead may spoil the fun of other users of which the play-out is running behind, e.g., by shouting ‘Gooooaal’ and thereby giving away the imminent goal. As such, it may be desirable to synchronize the play-out of the soccer match across the different locations to a common target, such as a reference play-out timestamp.

In general, the reference play-out to which the play-out of a media stream is to be synchronized may take various forms, including but not limited to: a) the play-out of the media stream at one or more further destinations, b) the play-out of one or more further media streams, and c) clock information indicating a reference timing of the play-out of the media stream. These use-cases are known per se from the field of media synchronization, and also referred to as a) inter-destination synchronization, b) inter-stream synchronization and c) intra-stream synchronization, respectively. Together with related synchronization use-cases and techniques, these synchronization use-cases will be in short referred to as media synchronization.

For example, inter-destination media synchronization may involve carrying out a synchronization between play-out of content at different destinations. Here, the play-out at one destination may constitute a reference for the play-out at another destination. With inter-stream synchronization, the play-out of one media stream, e.g., a video stream, may constitute a reference for the play-out of another media stream, e.g., an audio stream, or vice versa, e.g., to achieve lip synchronization. With intra-stream synchronization, the original timing of a recording, e.g., 25 frames per second or 44 kHz audio, may constitute a reference for the play-out of a media stream in time. With event-based synchronization, an original timing of an event, e.g., the timing of questions to an audience in a play-along quiz show, may constitute a reference for an actual presentation of such events during the broadcast of such a quiz show.

It is noted that media synchronization may be carried out to a level where the play-out of a media stream is fully synchronized with a reference play-out, or it may at least be intended to carry out the synchronization to said level. However, it may also be desired to perform synchronization to a level other than said full synchronization. For example, if it is known that a video frame buffer causes a 25 ms delay further onward in a media processing chain, it may be desirable to synchronize a video stream and an audio stream to the level of the video stream being ahead of the audio stream by 25 ms. Accordingly, media synchronization may purposefully establish a predetermined time delay to establish a target level of synchrony.

Media synchronization may involve performing one or more synchronization actions. For example, if the play-out of the media stream by the play-out device is ahead of the reference play-out, the former play-out may need to be delayed. Conversely, if the play-out of the media stream by the play-out device is behind the reference play-out, the former play-out may need to be advanced. Synchronization actions may take various forms, including seeking forward or backward in the media stream (also referred to as ‘jumping’) and temporarily adjusting the play-out rate (also referred to as ‘adaptive media play-out’). Synchronization actions may be performed by the play-out device, but also by another entity, e.g., a stream source or network buffer.

Disadvantageously, there may be a structural deficiency in the obtaining of synchronicity between the play-out of the media stream by the play-out device and the reference play-out. Here, the term ‘structural deficiency’ may refer to a limitation in the obtaining of the synchronicity which is not addressed by performing a synchronization action once, or by adjusting the common target in the media synchronization. Such a limitation may be associated with the play-out device, or with the delivery of the media stream to the play-out device. Namely, the limitation may be such that the synchronization action cannot be performed, that the synchronization action only establishes an insufficient degree of synchronicity, or that a sufficient degree of synchronicity is only established temporarily before reverting to an insufficient degree.

The existence of a structural deficiency in the obtaining of synchronicity with a reference play-out may trigger synchronization actions which in turn may cause frequent and/or large play-out distortions. Here, the term ‘play-out distortion’ refers to an irregularity in the play-out caused by the synchronization action, resulting in a deviation from the regular, typically continuous, play-out of the media stream at the regular play-out rate. For example, the user may notice the play-out of the media stream frequently pausing as a consequence of a structural deficiency in the obtaining of synchronicity, e.g., in case the play-out is structurally running ahead of the reference play-out. The structural deficiency may also increase the delays involved in starting up streaming of a media stream, or when changing to another media stream. The structural deficiency may also result in sufficient synchronicity not being established at all. This may be the case when a buffer associated with the play-out device is of an insufficient size to accommodate the buffering required by the synchronization actions. Accordingly, it may not be possible to sufficiently pause the play-out of the media stream to allow the reference play-out to catch up.

### SUMMARY OF THE INVENTION

It would be advantageous to obtain a system or method which addresses a structural deficiency in the obtaining of a degree of synchronicity between the play-out of a media stream by a play-out device and a reference play-out out.

The following aspects of the invention involve a play-out device reporting a quality of sync metric to a metric subsystem, which may then be analyzed to identify the structural deficiency. A corrective action may then be scheduled to address the structural deficiency. Examples of corrective actions include, but are not limited to, re-clustering of play-out devices, adjusting priority and/or bandwidth in the streaming, etc. As such, the quality of experience of one or more users experiencing the play-out may be improved. The invention is applicable to various forms of media synchronization, such as inter-destination synchronization and/or inter-media synchronization.

A first aspect of the invention may provide a system for media synchronization, the system comprising:
a play-out device for play-out of a media stream;
a synchronization subsystem for synchronizing the play-out of the media stream by the play-out device with a reference play-out, thereby obtaining a degree of synchronicity with the reference play-out;
wherein the play-out device comprises:
a quality of sync subsystem for determining a quality of sync metric during the play-out of the media stream, the quality of sync metric being indicative of a structural deficiency in the obtaining of the synchronicity with the reference play-out;
a reporting subsystem for externally reporting the quality of sync metric;
the system further comprising:
a metric subsystem for i) receiving the quality of sync metric from the play-out device, ii) analysing the quality of sync metric to identify the structural deficiency, and iii) scheduling a corrective action to address the structural deficiency.

A further aspect of the invention may provide the play-out device.

A further aspect of the invention may provide data representing the quality of sync metric reported by the play-out device.

A further aspect of the invention may provide a method for media synchronization in a system comprising a play-out device for play-out of a media stream, wherein the play-out of the media stream by the play-out device is synchronized with a reference play-out, thereby obtaining a degree of synchronicity with the reference play-out, the method comprising,

in the play-out device:
determining a quality of sync metric during the play-out of the media stream, the quality of sync metric being indicative of a structural deficiency in the obtaining of the synchronicity with the reference play-out;
externally reporting the quality of sync metric;

and in a metric system:
receiving the quality of sync metric from the play-out device,
analysing the quality of sync metric to identify the structural deficiency;
scheduling a corrective action to address the structural deficiency.

A further aspect of the invention may provide a computer program product comprising instructions for causing a processor system to perform the method.

Embodiments are defined in the dependent claims.

The above measures involve a play-out device which may render a media stream to a user, e.g., by rendering an audio/video component of the media stream, by rendering a quiz question represented by an event stream, etc. A non-limiting example may be that a user may be provided with a display of a video stream on a display.

A synchronization subsystem may be provided which may, at least to a certain degree, synchronize the play-out of the media stream by the play-out device to a reference play-out. Such synchronization may involve one or more synchronization actions being performed. It will be appreciated that depending on the type of media synchronization, the reference play-out to which the play-out is synchronized may take various forms, including play-out of the media stream at a further destination (inter-destination synchronization), play-out of a further media stream (inter-stream synchronization), and clock information indicating a reference timing of the play-out of the media stream (intra-stream synchronization). A non-limiting example may be that the play-out of the media stream may be synchronized across multiple play-out devices, with the reference play-out being represented by timing information provided by the synchronization subsystem defining a common target for the play-out devices. An example of a common target is a reference playback timestamp. It will be appreciated and further elucidated that the location of the synchronization subsystem, as well as the possible synchronization action(s) being performed, may take various forms, as are known per se from the technical field of media synchronization.

The play-out device may, during the play-out of the media stream, determine a quality of sync metric which may be indicative of a structural deficiency in the obtaining of the synchronicity with the reference play-out. As such, data may be obtained which directly or indirectly identifies the structural deficiency. The data may be externally reported by the play-out subsystem and received by a metric subsystem which may then analyse the quality of sync metric to identify the structural deficiency. A non-limiting example is that if the quality of sync metric is constituted by a plurality of values associated with the play-out of the media stream, the metric subsystem may employ heuristics to explicitly identify the structural deficiency from the reported values. Having identified the structural deficiency, the metric subsystem may then schedule a corrective action which may be known or expected to address the structural deficiency. Here, the term ‘corrective action’ may refer to an action which, contrary to a synchronization action, structurally addresses a limitation associated with the play-out device, or with the delivery of the media stream to the play-out device.

The inventors have recognized that a structural deficiency in the obtaining of a sufficient degree of synchronicity between the play-out of the media stream by the play-out device and the reference play-out may be observable to one or more users. For example, the structural deficiency may result in frequent buffering, skipping or pausing of the play-out of the media stream. Another example is that an insufficient degree of synchronicity may be directly observable by the user(s), e.g., when experiencing the play-out on a television and a ‘second screen’ such as a tablet device or smartphone. As such, the structural deficiency in the obtaining of synchronicity may cause the user(s) experiencing the play-out of the media stream to have an insufficient quality of experience despite or in consequence of synchronization actions taking place. By being indicative of the structural deficiency, the reported quality of sync metric may at the same time be indicative of the quality of experience obtained by the user(s). Accordingly, a corrective action may be scheduled which addresses the structural deficiency and thereby an insufficient quality of experience. Compared to the mere (repeated) performing of synchronization actions, an advantage may be that fewer synchronization actions may be needed after performing the corrective action. Since a synchronization action typically results in a play-out distortion in the play-out, the corrective action may result in fewer or less noticeable play-out distortions. In fact, it may not even be possible to perform a synchronization action in view of the structural deficiency, but upon determining the structural deficiency, a corrective action may be possible. A non-limiting example may be that an insufficient buffer size may prevent the play-out of a broadcast stream being paused for a sufficient time so as to allow the play-out of a corresponding HTTP-based stream by another play-out device to ‘catch up’. However, it may be possible to take a corrective action, e.g., by increasing the bandwidth of the HTTP-based streaming to the other play-out device. Accordingly, it may not be needed anymore to pause the play-out of the broadcast stream for a prolonged time. Namely, the increase in bandwidth may enable the HTTP-based stream to ‘catch up’. It will be appreciated that various other types of corrective actions may be taken so as to address different types of structural deficiencies.

In an embodiment, the play-out device may be configured for determining the quality of sync metric based on:
an occurrence of one or more playback operations performed by the play-out device during play-out of the media stream; and/or
a numerical measure of the degree of synchronicity obtained by the play-out device with the reference play-out.

The term ‘playback operation’ may refer to an operation associated with the play-out which is initiated by the play-out device rather than by a user. Examples of playback operations initiated by the play-out device may include the following: a pausing of the play-out, a stopping of the play-out, a resuming of the play-out, a starting of the play-out, a seeking in the media stream, a change in speed of the play-out, a frame drop during the play-out, and a representation switch of the media stream in adaptive streaming. The inventors have recognized that one or more occurrences of a playback operation may be indicative of a structural deficiency in the obtaining of the synchronicity. Likewise, the degree of synchronicity obtained by the play-out device with the reference play-out may be indicative of such a structural deficiency. Accordingly, the quality of sync metric may be generated based on a numerical measure of the degree of synchronicity. A non-limiting example may be that a difference between a current playback timestamp of the play-out device and a reference playback timestamp provided by the synchronization subsystem may be reported, or that a mean and variance of the difference may be reported.

In an embodiment, the play-out device may be configured for i) when performing the playback operation, registering a reason for performing the playback operation, thereby obtaining a registered reason, and ii) determining the quality of sync metric further based on the registered reason. There may be a reason for the play-out device initiating the playback operation. For example, the play-out may be stopped by the play-out device in response to, e.g., the media stream ending or a re-buffering. The latter may be indicative of a structural deficiency in obtaining synchronous play-out, whereas this may not need to be the case for the former. By determining the quality of sync metric further based on the registered reason, the quality of sync metric may be generated to be more accurately indicative of the structural deficiency.

In an embodiment, the play-out device may be configured for formatting the quality of sync metric to indicate at least one of:
a time period to which the quality of sync metric pertains,
a number of occurrences of a type of playback operation, and
a difference, or a mean and a variance of the difference, between a current playback timestamp of the play-out device and a reference playback timestamp provided by the synchronization subsystem.

The data reported by the play-out device may thus indicate the abovementioned information, e.g., in a textual or non-textual data format. The indication of the time period to which the quality of sync metric pertains may be of relevance in a periodic reporting of the quality of sync metric in that it may enable the reporting of the quality of sync metric to be distinguished from earlier and/or later reports. The time period may also provide a context to the number of occurrences of a type of playback operation. The number of occurrences may be indicative of a structural deficiency in obtaining synchronous play-out. For example, numerous occurrences of pausing and resuming may be indicative of an insufficient priority and/or bandwidth in the streaming of the media stream. Moreover, the claimed difference, or its mean and variance, may represent a numerical measure of the degree of synchronicity obtained by the play-out device with the reference play-out, and may thereby be indicative of a structural deficiency in obtaining synchronous play-out.

In an embodiment, the play-out device may be part of one or more play-out devices for play-out of the media stream, and the corrective action may be an adjustment in at least one of:
delivery of the media stream to at least one of the one or more play-out devices, and
a boundary condition associated with the synchronizing of the play-out of the media stream by the play-out device with the reference play-out.

The play-out device may be part of a group of one or more play-out devices playing-out the media stream. The corrective action scheduled by the metric subsystem may adjust a delivery of the media stream to at least one of the one or more play-out devices. As such, the adjustment may be in what is being delivered, or how the delivery is performed. Additionally or alternatively, the corrective action may adjust a boundary condition associated with the synchronizing of the play-out of the media stream by the play-out device with the reference play-out. Both types of corrective actions are well suited for addressing structural deficiencies in obtaining synchronous play-out.

In an embodiment, the adjustment in the delivery of the media stream may comprise at least one of:
a switching to a different media stream and/or to a different stream source for the same media stream, for at least one of the one or more play-out devices;
an adjustment in priority and/or bandwidth in the streaming of the media stream to at least one of the one or more play-out devices; and
an adjustment in a timing of the delivery of the media stream to at least one of the one or more play-out devices.

The structural deficiency may be associated with the delivery of a particular media stream and/or the processing of the particular media stream by the play-out device. By switching to a different media stream, this type of structural deficiency may be addressed. The structural deficiency may also be associated with a stream source, in that the stream source may not be able to deliver or reliably deliver the media stream. By switching to a different stream source for the same media stream, this type of structural deficiency may be addressed. The structural efficiency may also be associated with an insufficient priority and/or bandwidth allocated as part of the streaming of the media stream. By adjusting the priority and/or bandwidth being allocated to the media stream, this type of structural deficiency may be addressed. The structural deficiency may also be associated with a too early or too late delivery of the media stream, causing the play-out device not being able to obtain a sufficient degree of synchronicity with the reference play-out. By adjusting the timing of the delivery of the media stream, this type of structural deficiency may be addressed.

In an embodiment, the adjustment in the boundary condition may comprise at least one of:
a clustering or re-clustering of play-out devices in two or more clusters to which the media synchronization is separately applied to obtain a more homogenous quality of sync than would have been obtained when applying the media synchronization to a single cluster comprising all of the play-out devices;
an adjustment of the synchronization threshold in at least one of the one or more play-out devices, the synchronization threshold defining an allowed level of asynchrony between the play-out of the media stream and the reference play-out before a synchronization action is performed by a respective play-out device.

In case of there being multiple play-out devices, a clustering or re-clustering of play-out devices in two or more clusters to which the media synchronization is separately applied may result in a more homogenous quality of sync than would have been obtained when applying the media synchronization to a single cluster comprising all of the play-out devices. For example, play-out devices having a high latency with respect to a stream source, and thus needing a long time to perform, e.g., a program or channel switch, may result in play-out devices having a low latency to also take a long time to perform the program or channel switch in order to maintain a sufficient degree of synchronicity. By clustering all ‘high-latency’ play-out devices in a separate cluster from the low-latency′ play-out devices, a more homogenous quality of sync may be obtained in each cluster individually and thereby an overall higher quality of experience. It is noted that clustering based on latency is merely an example and that there are also various other suitable clustering criteria, such as Quality of Service parameters known per se within the field of telecommunications. Additionally or alternatively, the synchronization threshold in at least one of the one or more play-out devices may be adjusted. For example, if a low quality of sync is reported, the synchronization threshold may be adjusted to allow a larger deviation from the reference play-out, thereby reducing the frequency of the synchronization actions being performed. Conversely, if a high quality of sync is reported, the synchronization threshold may be adjusted to maintain a smaller deviation from the reference play-out.

In an embodiment, the metric subsystem may be configured for effecting the corrective action by sending an instruction indicative of the adjustment to be performed to at least one of: at least one of the one or more play-out devices, a stream source providing the media stream, the synchronization subsystem, and a network entity involved in the streaming of the media stream to at least one of the one or more play-out devices. The corrective action may be scheduled by the metric subsystem but performed by another entity. For that purpose, the metric subsystem may send an instruction indicative of the adjustment to be performed to the respective entity.

In an embodiment, the metric subsystem may be configured for scheduling the corrective action in response to the quality of sync metric falling below a predetermined quality threshold. The quality of sync metric may be reported or representable as a numerical value. The corrective action may be scheduled when the numerical value falls below a particular threshold. The particular threshold may represent, e.g., the quality of experience being deemed to become insufficient. As such, the metric subsystem may timely schedule a corrective action.

In an embodiment, communication between the play-out device and the metric subsystem may take place in accordance with a client-server communication scheme, and the play-out device may represent the client and the metric subsystem may represent the server in the client-server communication scheme.

It will be appreciated by those skilled in the art that two or more of the above-mentioned embodiments, implementations, and/or aspects of the invention may be combined in any way deemed useful.

Modifications and variations of the play-out device, the data representing the quality of sync metric, the method and/or the computer program product, which correspond to the described modifications and variations of the system, can be carried out by a person skilled in the art on the basis of the present description.

The invention is defined in the independent claims. Advantageous yet optional embodiments are defined in the dependent claims.

### BRIEF DESCRIPTION OF THE DRAWINGS

These and other aspects of the invention are apparent from and will be elucidated with reference to the embodiments described hereinafter. In the drawings,

FIG. 1 shows an embodiment of a system for media synchronization comprising a metric subsystem for scheduling a corrective action which addresses a structural deficiency in the obtaining of synchronicity in the media synchronization;

FIG. 2 shows a play-out device comprising a quality of sync subsystem for determining a quality of sync metric during the play-out of the media stream and a reporting subsystem for externally reporting the quality of sync metric;

FIG. 3 shows an embodiment of data representing the quality of sync metric as reported by the play-out device;

FIG. 4 illustrates an evaluation of a quality of sync metric providing the mean and variance of a skew between a reference and actual playback timestamp;

FIG. 5 shows an example of the use of quality of sync metric reporting within the context of inter-destination media synchronization (IDMS) session orchestration;

FIG. 6 illustrates an embodiment of a corrective action, namely a re-clustering of play-out devices in two clusters to which the media synchronization is separately applied to obtain a more homogenous quality of sync;

FIG. 7 illustrates another embodiment of a corrective action, namely a switching to a different media stream in the context of adaptive streaming;

FIG. 8 illustrates another embodiment of a corrective action, namely an adjustment in priority in the streaming of the media stream;

FIG. 9 illustrates another embodiment of a corrective action, namely an adjustment of a synchronization threshold;

FIG. 10 illustrates another embodiment of a corrective action, namely an adjustment in a timing of the delivery of the media stream;

FIG. 11 shows a method for media synchronization in which a corrective action is scheduled to address a structural deficiency in the obtaining of synchronicity in the media synchronization; and

FIG. 12 shows a computer program product comprising instructions for causing a processor system to perform the method.

It should be noted that items which have the same reference numbers in different Figures, have the same structural features and the same functions, or are the same signals. Where the function and/or structure of such an item has been explained, there is no necessity for repeated explanation thereof in the detailed description.

### LIST OF REFERENCE NUMERALS

The following list of reference numbers is provided for facilitating the interpretation of the drawings and shall not be construed as limiting the claims.
010 streaming source
020 media stream
030 metrics database
032 data stored in metrics database
034 data retrieved from metrics database
100-104 instances of play-out device
100A quality of sync subsystem
100B reporting subsystem
110 data representing quality of sync metric
112 time period data
114 occurrence data
116 skew data
120 synchronization subsystem
130 data representing synchronization instruction
140 metric subsystem
140A metrics server
140B quality of sync analysis unit
140C session management unit
150 data representing corrective action instruction
160A-160C cluster of play-out devices
161-164 sets representing play-out devices
200 IDMS session orchestration
210 clustering of clients
220 data collection from clients
230 evaluation of quality of sync metrics
240 quality of sync satisfactory
250 scheduling of corrective action
252 re-clustering of clients
300 method for media synchronization
310 determining quality of sync metric
320 externally reporting quality of sync metric
330 receiving quality of sync metric
340 analysing quality of sync metric
340 scheduling corrective action
360 computer readable medium
370 non-transitory data representing instructions

### DETAILED DESCRIPTION OF EMBODIMENTS

The play-out of a media stream by a play-out device may be synchronized by a synchronization subsystem with a reference play-out, thereby obtaining a degree of synchronicity with the reference play-out. To address a structural deficiency in the obtaining of the synchronicity with the reference play-out, the play-out device may report a quality of sync metric to a metric subsystem, which may then be analysed to identify the structural deficiency. A corrective action may then be scheduled to address the structural deficiency. Examples of corrective actions include re-clustering of play-out devices, adjusting priority and/or bandwidth in the streaming, etc. As such, the quality of experience of one or more users experiencing the play-out may be improved.

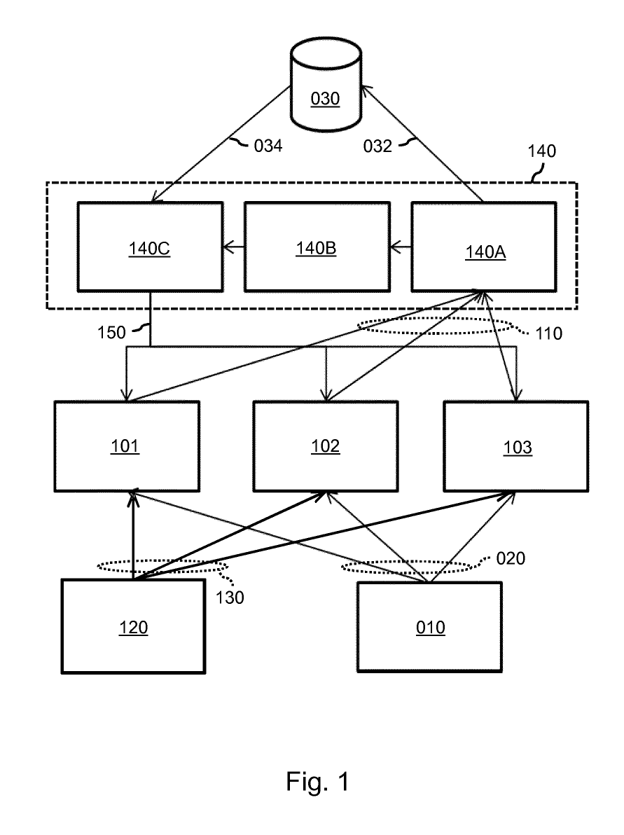

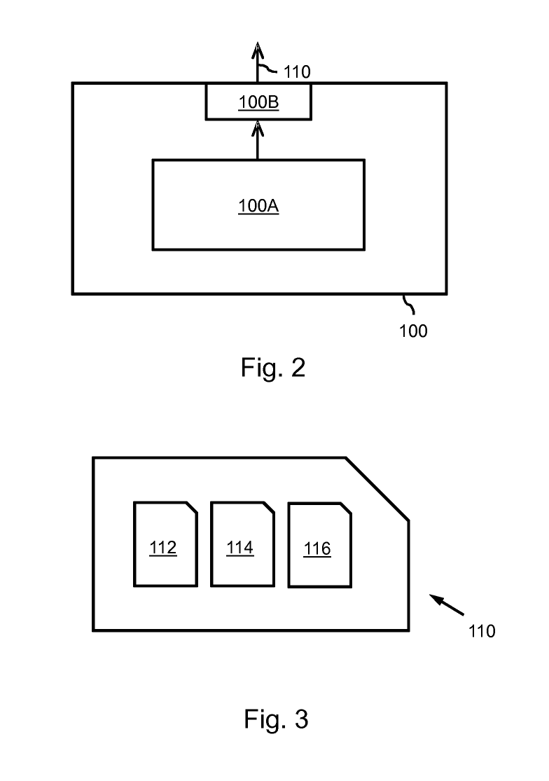

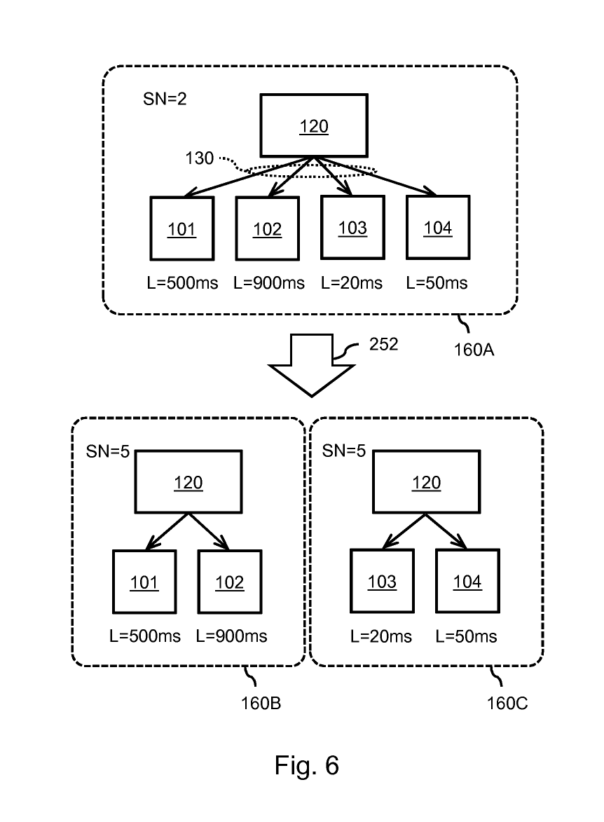

An embodiment of a system comprising the play-out device and the metric subsystem will be described with reference to FIG. 1. Therein, the system is shown within the context of inter-destination media synchronization (IDMS). However, the concepts elucidated in FIG. 1 and further are not limited to IDMS but equally apply to other types of media synchronization. Various aspects of the quality of sync metric, including its format and subsequent analysis, will be further described with reference to FIGS. 2 to 4, whereas various aspects of the corrective action, including its type, scheduling and effectuation, will be further described with reference to FIGS. 6-10.

FIG. 1 shows an embodiment of a system for media synchronization. The system comprises a play-out device 101 for play-out of a media stream 020. The play-out device 101 is shown to obtain the media stream 020 from a stream source 010. An example of a stream source may be a media server. The system is further shown to comprise a synchronization subsystem 120 for synchronizing the play-out of the media stream by the play-out device with a reference play-out, thereby obtaining a degree of synchronicity with the reference play-out. In the example of FIG. 1, the reference play-out may be represented by a common target for a plurality of play-out devices 101-103 streaming the media stream 020. For example, the common target may be constituted by a reference playback timestamp, which may be communicated to the play-out devices 101-103 in the form of data 130 representing synchronization instructions. It is noted that the functionality of the synchronization subsystem 120 as described in this paragraph is known per se from the technical field of media synchronization.

As will be further elucidated with reference to FIG. 2, the play-out device 101 may comprise a quality of sync subsystem for determining a quality of sync metric during the play-out of the media stream. The quality of sync metric may indicative of a structural deficiency in the obtaining of the synchronicity with the reference play-out. The play-out device 101 may further comprise a reporting subsystem for externally reporting the quality of sync metric. Namely, the quality of sync metric may be reported in the form of data 110 representing the quality of sync metric. It is noted that in the embodiment of FIG. 1, all play-out devices 101-103 are configured for determining and externally reporting a quality of sync metric. However, this is not a limitation, in that only a subset of the play-out devices 101-103 may be configured for said purpose.

The system may further comprise a metric subsystem 140 for receiving the quality of sync metric from the play-out device, analysing the quality of sync metric to identify the structural deficiency, and scheduling a corrective action to address the structural deficiency. In the example of FIG. 1, the metric subsystem 140 is shown to be comprised of a metrics server 140A receiving the quality of sync metric, a quality of sync analysis unit 140B for analysing the quality of sync metric to identify the structural deficiency, and a session management unit 140C for scheduling the corrective action. However, this is not a limitation in that the metric subsystem 140 may also be embodied differently, e.g., as a single unit or in a differently distributed manner.

The quality of sync metrics as reported by the play-out devices may be stored as data 032 in a metrics database 030. Conversely, data 034 may be retrieved from the metrics database 030, e.g., for analysis or determining the corrective action.

The metric subsystem 140 may be configured for scheduling the corrective action in accordance with a predefined criterion. For example, the corrective action may be scheduled in response to the quality of sync metric, or a measure derived therefrom, falling below a predetermined quality threshold. As will be elucidated with further reference to FIGS. 6-10, depending on the type of corrective action, the corrective action may then be effected in various ways. For example, as also illustrated in FIG. 1, the metric subsystem 140 may be configured for effecting the corrective action by sending data 150 representing an instruction indicative of the adjustment to be performed to one or more play-out devices 101-103. Additionally or alternatively, the data may be sent to the stream source 010, the synchronization subsystem 120, or a network entity involved in the streaming of the media stream. Likewise, the metric subsystem 140 may also autonomously carry out the corrective action.

It is noted that the communication between the play-out device(s) 101-103 and the metric subsystem 140 may take place in accordance with a client-server communication scheme. Herein, a play-out device may represent the client and the metric subsystem 140 may represent the server in the client-server communication scheme. Accordingly, the play-out device(s) 101-103 may also be referred to as ‘client’ in the following. It is further noted that in the example of FIG. 1, the metrics server 140A of the metric subsystem 140 may provide said server functionality.

FIG. 2 shows a play-out device 100. It is noted that the term ‘play-out device’ may refer to devices such as, but not limited to, TVs, DVB players and recorders, mobile phones, cameras, (digital) radio's, music (mp3) players, PCs, laptops, tablets, smartphones, smart glasses, smart watches, set-top boxes, media players, car hi-fi installations, professional audio and video equipment, etc. As opposed to a conventional play-out device, the play-out device 100 shown in FIG. 2 comprises a quality of sync subsystem 100A for determining a quality of sync metric during the play-out of the media stream and a reporting subsystem 100B for externally reporting the quality of sync metric. Accordingly, the play-out device 100 may output data 110 representing the quality of sync metric. Although not shown explicitly in FIG. 2, such data 110 may be output onto a communication channel, thereby making the data directly or indirectly available to the metric subsystem. The communication channel may take any suitable form, and may comprise wireless and/or wired portions. Suitable forms of communication include, e.g., Wi-Fi, Bluetooth, ZigBee, Fibre, Ethernet, etc. The reporting of the quality of sync metric may be Internet Protocol (IP) based, or in general, network-based, and may be based on the WebSocket protocol RFC 6455. The reporting subsystem may be appropriately configured for said communication, e.g., by comprising an interface of a type corresponding to the type of communication channel.

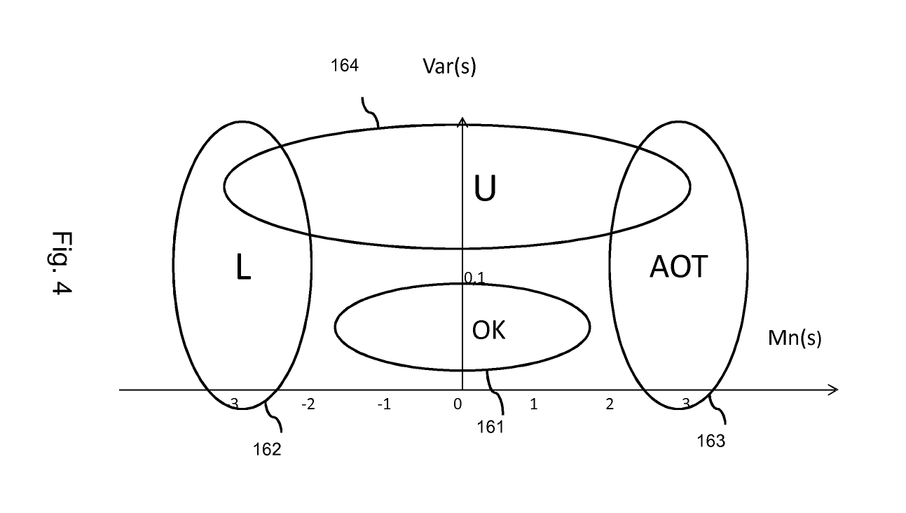

FIG. 3 shows an embodiment of data representing the quality of sync metric as reported by the play-out device. In general, the play-out device may determine the quality of sync metric based on an occurrence of one or more playback operations performed by the play-out device during play-out of the media stream. Such occurrence(s) may be indicative of a structural deficiency in the obtaining of the synchronicity with the reference play-out. It is noted that, as opposed to a ‘user action’ or ‘user operation’, which may be an operation performed by the play-out device which is initiated by the user, the playback operation may be an operation performed by the play-out device which is initiated by the play-out device rather than the user. Examples of playback operations include a pausing of the play-out, a stopping of the play-out, a resuming of the play-out, a starting of the play-out, a seeking in the media stream, a change in speed of the play-out, a frame drop during the play-out, and a representation switch of the media stream in adaptive streaming. The play-out device may be configured for formatting the quality of sync metric to indicate a number of occurrences of a type of playback operation. As such, the data 110 may comprise occurrence data 114 representing said occurrences. Additionally, the quality of sync metric may be formatted to indicate a time period to which the quality of sync metric pertains. As such, the data 110 may comprise time period data 112 representing said time period. Additionally, when a reason is registered for initiating and/or performing the playback operation, the quality of sync metric may be formatted to indicate the registered reason.

An example of a quality of sync metric may be the following. Here, the quality of sync metric is defined as an extension of an existing metric, namely of a playlist metric defined within MPEG—Dynamic Adaptive Streaming over HTTP (DASH), e.g., in ISO/IEC 23009-1:2014. The playlist metric is an example of a metric that a DASH client may be asked to report. Although the reporting mechanism is not defined within ISO/IEC 23009-1:2014, the metrics are. The definition of the playlist metric is user-centric as the definition specifies: “A playback period is the time interval between a user action and whichever occurs soonest of the next user action, the end of playback or a failure that stops playback”, referring to a user-initiated operation performed by the play-out device. The playlist metric may be modified so as to additionally or alternatively serve as quality of sync metric. Below, underlined text represents a modification of the playlist metric defined in ISO/IEC 23009-1:2014. Keys of the playlist metric which have not been modified have been omitted below.

| Key | Type | Description |
|---|---|---|
| Playlist | List | A list of playback periods. A playback period |
| | | is the time interval between a user action |
| | | or a player action and whichever |
| | | occurs soonest of the next user action, |
| | | the next player action, the end of playback, |
| | | or a failure that stops playback. |
| Entry | Object | A record of a single playback period. |
| Start | Real-Time | Timestamp of the user or player action that |
| | | starts the playback period. |
| Mstart | Media-Time | The presentation time at which playout was |
| | | requested by the user or player action. |
| Starttype | Enum | Type of user or player action which triggered |
| | | playout |
| | | New playout request (e.g. initial playout or |
| | | seeking) |
| | | Resume from pause |
| | | quality change |
| | | Start of a metrics collection period (hence |
| | | earlier entries in the play list not collected) |
| Actiontype | Enum | Type of action that initiated the play-out: |
| | | user action |
| | | player action |
| Trace | List | List of periods of continuous rendering |
| | | of decoded samples. |
| Entry | Objects | Single entry in the list. |
| Stopreason | Enum | The reason why continuous presentation of |
| | | this Representation was stopped. Either: |
| | | Representation switch (not relevant in |
| | | case of progressive download) |
| | | rebuffering |
| | | behind the IDMS reference playback |
| | | timestamp |
| | | ahead of the IDMS reference playback |
| | | timestamp |
| | | user request |
| | | end of Period |
| | | end of content |
| | | end of a metrics collection period |
| | | failure |

Additionally or alternatively to the quality of sync metric being determined based on an occurrence of one or more playback operations performed by the play-out device during play-out of the media stream, the quality of sync metric may be determined based on a numerical measure of the degree of synchronicity obtained by the play-out device with the reference play-out. An example of such a numerical measure is a difference, or a mean and a variance of the difference, between a current playback timestamp of the play-out device and a reference playback timestamp provided by the synchronization subsystem. Such a difference may also be referred to as ‘skew’. Accordingly, the data 110 shown in FIG. 3 may comprise skew data 116 representing said skew, and/or the mean and the variance of the skew.

In an embodiment, the quality of sync metric may be as follows:

| Key | Type | Description |
|---|---|---|
| QoSyncList | List | A list of QoSync monitoring periods. |
| | | A QoSync monitoring period |
| | | collects over a given time |
| | | interval information pertaining |
| | | to the quality of the synchronization |
| | | within a IDMS session. |
| Entry | Object | A record of a single QoSync |
| | | monitoring period. |
| start | Real-Time | Timestamp of the start time of the |
| | | monitoring period |
| end | Real-Time | Timestamp of the end time of the |
| | | monitoring period |
| seekevents | Integer | Number of seek event occurrences caused |
| | | by the IDMS heuristic |
| pauseevents | Integer | Number of pause event occurrences |
| | | caused by the IDMS heuristic |
| switchevents | Integer | Number of Representation switch event |
| | | occurrences caused by the IDMS heuristic |
| skewmean | Real | Average of the skew between the reference |
| | | and the actual playback timestamp. |
| | | The skew at time t is the difference |
| | | of the current timestamp and the |
| | | reference timestamp. Note that a |
| | | negative skew means that the |
| | | client lags behind the reference |
| | | playback timestamp. Inversely, |
| | | a positive skew means that the |
| | | client is ahead of the reference |
| | | playback timestamp. |
| skewvariance | Real | Variance of the skew. |

By reporting the skew, or the mean and variance of the skew, between a reference and actual playback timestamp, the metric subsystem may determine an existence of a structural deficiency in the obtaining of the synchronicity with the reference play-out. This is graphically illustrated in FIG. 4, in which the mean of the skew as reported by a play-out device is set out on the horizontal axis against the variance of the skew on the vertical axis. In addition, different sets 161-164 of play-out devices are illustrated, namely a first set 161 of play-out devices being deemed ‘OK’ in that their streaming does not appear to suffer from a structural deficiency. Namely, the first set 161 shows a low mean skew and a low variance. Thus, a play-out device belonging to the first set 161 may generally be well-aligned with a reference playback timestamp. A second set 162 of play-out devices may be deemed to represent tagging clients' in that they have a negative mean skew and a relatively low variance. A concrete example may be a skew mean of −2.800 s and a skew variance of 0.004 s². Thus, a play-out device belonging to the second set 162 may be lagging behind with respect to a reference playback timestamp. A third set 163 of play-out devices may be deemed to represent Ahead-of-time clients' in that they have a positive mean skew and a relatively low variance. A concrete example may be a skew mean of +3.000 s and a skew variance of 0.01 s². Thus, a play-out device belonging to the third set 163 may be running ahead with respect to a reference playback timestamp. A fourth set 164 of play-out devices may be deemed to represent ‘Unstable clients’ in that they have a small mean skew and a relatively high variance. A concrete example may be a skew mean of +0.2 s and a skew variance of 0.25 s². Thus, a play-out device belonging to the fourth set 162 may show unstable behaviour, sometimes lagging behind with respect to a reference playback timestamp and sometimes running ahead thereof.

It is noted that the quality of sync metric may combine the occurrence of one or more playback operations performed by the play-out device during play-out of the media stream with a numerical measure of the degree of synchronicity obtained by the play-out device with the reference play-out. Effectively, the quality of sync metric may be comprised of two parts, e.g., two ‘sub-metrics’. Here, the reporting of occurrences of playback operations may be deemed to be a ‘subjective’ metric, in that it may reflect a consequences of structural difficulties encountered by the play-out in obtaining synchronicity with the reference play-out, which may decrease the quality of experience of the user(s) experiencing the play-out. The reporting of the numerical measure of the degree of synchronicity may be termed an ‘objective’ metric in that it may directly represent the degree of synchronicity obtained by the play-out device.

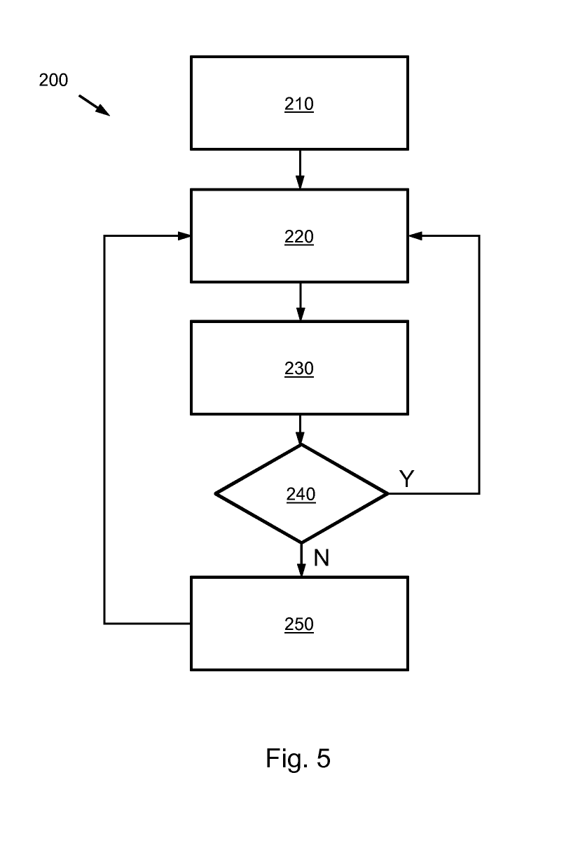

FIG. 5 shows an example of the use of quality of sync metric reporting within the context of inter-destination media synchronization (IDMS) session orchestration. Here, the term ‘client’ is used. An example of a client is a play-out device. Performing IDMS is conventionally a multi-step process, involving steps such as:

1. Measuring the play-out timing of the media streams at clients within a synchronization cluster, and communicating this timing to the other participants or to a centralised synchronization server.

2. Determining the relative play-out timing between clients, and in general determining the slowest clients. In case of a central synchronization server, this information may be communicated as synchronization instructions to all clients.

3. Delaying of the play-out at all clients to match the slowest client, to synchronise the play-out across all clients.

These steps may be performed in various architectures, including but not limited to A) Sync Maestro Scheme, where all clients may report about their play-out to a single server, and the single server may distribute instructions to all clients, B) Distributed Control Scheme, where all clients may report about their play-out to all other clients, and each client may autonomously make synchronization decisions, and C) Master/Slave scheme, where one client is designated as master client which reports about its play-out to all other clients, who must adhere to the master's play-out timing.

The inventors have recognized that due to fast technical developments, the characteristics of the clients to be synchronised are getting more and more diverse in terms of screen capabilities, available bandwidth, computation power, networking capabilities, etc. As a result, the quality of the experience that the users perceive in a synchronised media session may be poor for various reasons.

For example, the slowest client may contribute to lowering the quality of experience not only of its user but of everyone in the session. As is known from the technical field of media synchronization, the reference point in time where the clients of the same session have to adjust to may be determined by the position of the slowest client. As such, when watching live content, the slowest client may force all other clients in, e.g., an IDMS cluster to slow down. The extent of this slow-down may be such that the delay compared to the live edge may become unacceptably large.

Moreover, if there are large play-out differences between clients, a significant amount of buffering may be needed. For example, when changing channels during a synchronised session, channel changing delays may increase due to this buffering (if synchronised channel change is desired along the synchronised viewing), which may lead to excessively large channel changing delays. Also, the start-up delay for a synchronization session may be large if the play-out differences are large. In this respect, it is noted that typical delay differences for TV broadcasts may range from a few seconds delay differences to over one minute when including internet broadcasts.

Yet another reason for a poor quality of experience may be that due to, e.g., clock drift at some of the clients, many synchronization actions may be carried out, resulting in, e.g., continuous skipping ahead or pausing of the play-out to synchronise the play-out across clients. This may also hold for varying network circumstances. For example, network congestion may lead to buffer underruns and thus play-out discontinuities for one client, which may disturb the play-out of all clients in the session.

These synchronization actions may be visible to the user(s), and thus negatively impact their quality of experience. Artefacts such as the play-out temporarily pausing, jumping to another part of the media stream, or playing faster or slower than normal, or large waiting times during a channel change, are all examples of visible synchronization actions. It may thus be a problem to carry out IDMS with a high level of quality of experience for the user(s). FIG. 5 illustrates how the reporting of a quality of sync metric by a client, such as a play-out device, and its subsequent use by a metric subsystem, may lead to an improvement in the quality of experience of the user(s).

In particular, FIG. 5 shows a flowchart 200 showing a modified IDMS session orchestration which involves clustering 210 of clients, data collection 220 from clients, evaluation 230 of quality of sync metrics, determining 240 whether the quality of sync is satisfactory, and depending on the outcome scheduling 250 a corrective action. Here, the data collection 220 may refer to one or more play-out devices reporting their quality of sync metric to a metric subsystem, the evaluation 230 may refer to the metric subsystem analysing the quality of sync metric to identify a structural deficiency, and the corrective action may be scheduled 250 to address the structural deficiency.

FIG. 5 may be explained further with joint reference to the metric subsystem 140 shown in FIG. 1. When starting an IDMS session, the clients may be part of an IDMS cluster. In a basic scenario, all clients may initially be part of the same IDMS cluster. The clients may then report information to the metrics server 140A, which may comprise one or more quality of service metrics. Such quality of service metrics are known per se within the field of media streaming and pertain to the quality of the connection that the client uses. For example, delay, jitter and available bandwidth are metrics that the client may measure against a given server, e.g., the server delivering the media stream to the client. These metrics may indicate how well and stable the circumstances are for that client, which may be taken into account when making decisions. The information reported by the clients may further pertain to another type of metric, namely the quality of sync metric. As indicated earlier with reference to FIGS. 1-3, the quality of sync metric may indicate occurrences of buffering events, device-initiated skip or pausing events, time until synchrony is below a threshold, etc., and may in general report on any other noticeable impact of the synchronization on the client's behaviour that may influence the quality of experience of the user(s).

The quality of sync analysis unit 140B may then evaluate the Quality of Synchronization for a subset or all of the clients based on the reported data. For example, the reported quality of sync metrics may be considered as ‘raw’ data from which the overall Quality of Synchronization may be computed, e.g., based on the number of player-initiated playback pauses or skipping events per minutes, etc. In case the Quality of Synchronization is deemed unsatisfactory, the session management unit 140C may then schedule a corrective action to be taken. Different types of corrective actions may be taken so as to address different types of structural deficiencies in the obtaining of the synchronicity with the reference play-out, which may thereby improve the Quality of Synchronization. It is noted that corrective actions differ from synchronization actions, in that they specifically address a structural deficiency in the obtaining of the synchronicity. An example of a corrective action is an adjustment in a delivery of the media stream to at least one of the one or more play-out devices. Another example is that the corrective action may comprise an adjustment in a boundary condition associated with the synchronizing of the play-out of the media stream by the play-out device with the reference play-out.

FIG. 6 illustrates an example of a corrective action involving the adjustment of a boundary condition, namely in the form of a re-clustering of play-out devices in two clusters to which the media synchronization is separately applied to obtain a more homogenous quality of sync. In FIG. 6, the play-out devices 101-104 may be initially put in a first cluster 160A. The play-out devices may have widely varying latency with respect to, e.g., a stream source providing the media stream. For example, a first play-out device 101 may have a latency of 500 ms, a second play-out device 102 may have a latency of 900 ms, a third play-out device 103 may have a latency of 20 ms and a fourth play-out device 104 may have a latency of 50 ms. It may be determined from the quality of sync metrics reported by the play-out devices 101-104 that a poor Quality of Synchronization is obtained. For example, when expressed in a numerical value on a Mean Opinion Score scale of [1 . . . 5] with 5 indicating a highest quality, the Quality of Synchronization (also referred to in short as ‘Syncness’) may have a value 2. This may be because the third play-out device 103 and the fourth play-out device 104 may need to buffer too much, and thus have a large delay compared to the live edge, thereby also effecting the delays involved in starting-up streaming and changing channels.

Accordingly, the metric subsystem may perform as corrective action a clustering or re-clustering of the play-out devices 101-104 in two or more clusters 160B, 160C to which the media synchronization may be separately applied to obtain a more homogenous quality of sync than would have been obtained when applying the media synchronization to the single cluster 160A comprising all of the play-out devices.

Such corrective action may involve the following: the play-out devices 101-104 may be separated and put together in separate clusters 160B, 160C. The clustering may be based on similarities which appear from the reported data. For example, ‘fast’ clients may be put together in a first cluster while ‘slow’ clients may be put together in second cluster. After such re-clustering, the Quality of Synchronization obtained in each of the clusters 160B, 160C may be greater than the one provided previously by the single cluster 160A, e.g., resulting in a ‘Syncness’ value of 5 instead of 2. Accordingly, a higher quality of experience may be obtained for the users of the play-out devices 101-104 in both clusters, e.g., by there being less buffering time for the fastest play-out devices 103-104 and thus there being less “wait” messages for the fastest play-out devices 103-104, the fastest ones being closer to the live edge, etc.

Within the context of MPEG-DASH, a workflow may be the following (here, further reference is made to units of the metric subsystem 140 shown in FIG. 1):

1. The session management unit 140C, acting as or representing an IDMS session manager, may communicate Session Information to clients. The Session Information may be part of a Media Presentation Description (MPD). It may comprise the quality of sync (QoSync) and quality of service (QoS) metrics to be reported by the clients, and identify the way and to whom the clients have to report said metrics. For example, the Session Information may identify the metrics server 140A.

2. The clients may join the session, e.g., by a client sending a “Join” message to the IDMS session manager to signal its participation.

3. The clients may start retrieving the media content, e.g., a media stream.

4. The clients may report the quality of sync and quality of service metrics to the metrics server 140A.

5. The quality of sync analysis unit 140B may determine whether some clients experience problems obtaining synchronicity with the reference playback timestamp, and in particular, whether there appears to exist a structural deficiency.

6. For example, clients A and B may report poor QoSync and may lag behind the reference playback timestamp. As such, the users of clients A and B may have a poor quality of experience. Clients C, D and F may report good QoSync metrics.

7. Because the session offers live content, the IDMS session manager may attempt to maintain the reference playback as close as possible to the live edge.

8. The IDMS session manager may therefore create a new session for clients A and B and send new Session Information to them. Additionally, the IDMS session manager may have verified that clients A and B have similar quality of service which increases the chance for them to synchronise together.

9. Clients A and B may join the new session and start synchronising.

10. Clients A and B may report good quality of sync metrics

11. Now two IDMS sessions are open, each representing a different cluster of clients. Session 1 comprising clients C, D and F may be the closest one to the live edge while Session 2 comprising clients A and B may be few seconds behind.

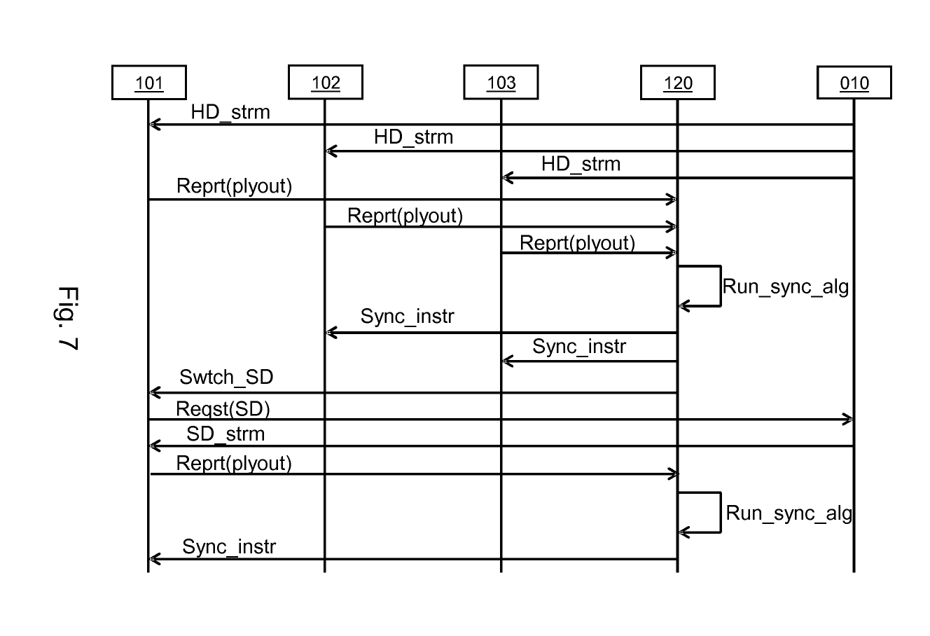

FIG. 7 illustrates another an example of a corrective action, namely one involving an adjustment in the delivery of the media stream. Such adjustment may involve switching to a different version (e.g., quality, frame rate, resolution) media stream for one or more clients. In the context of adaptive streaming, a re-clustering might be avoided if the ‘weakest’ client is able to keep up with the pace using a representation at a lower quality. For instance, the weakest client might consume a HD representation of media content which may necessitate a 10 second buffer in order to absorb fluctuations in its internet connection. However, other clients may be able to retrieve the HD content with only a 3 second buffer. As a result, either the weakest client may be put into a new cluster with similar clients where the weakest client may maintain the level of quality, or the weakest client may stay in the current cluster but may be instructed to retrieve a lower quality stream in order to synchronise the play-out with the rest of the clients. This type of adjustment in the delivery of the media stream, e.g., the switching of the media stream, may occur if the structural deficiency lies in decoding time and if switching to a different quality results in shorter decoding times. Note that this alternative media stream may be an existing one, or may be created on-demand. Such switching may be to a different quality, frame rate, resolution, etc., which may all have impact on the network usage and local processing requirements.

FIG. 7 shows an example data flow illustrating the above. Here, three clients are in a synchronization session, e.g., play-out devices 101-103. Each client 101-103 may receive an HD stream from the streaming source 010, as illustrated by respective arrows titled “HD_strm”, short for “HD stream”, and report about their play-out timing to the synchronization subsystem 120, as illustrated by respective arrows titled “Reprt(plyout)”, short for “Report(play-out)”. The synchronization subsystem 120 may, upon receiving the reports from the clients 101-103, run a synchronization algorithm, as illustrated by the arrow titled “Run_sync_alg”, short for “Run_sync_algorithm”. In this example, client 101 may be lagging behind for 10 seconds compared to clients 102 and 103. The synchronization algorithm may have a threshold of 2 seconds, and only clients within this threshold may be instructed to synchronise directly, as illustrated by respective arrows titled “Sync_instr”, short for “Sync_instructions”. Other clients, such as client 101, may receive other instructions. In this case, client 101 may be instructed to switch to an SD stream, as illustrated by the arrow titled “Swtch_SD”, short for “Switch_SD”. After client 101 has switched to the SD stream for the same media content, as illustrated by the arrows “Regst(SD)” and “SD_stm”, short for “Request(SD)” and “SD_stream”, respectively, client 101 may report about its play-out timing to the synchronization subsystem 120. The synchronization subsystem 120 may now determine that client 101 is playing out the media within 2 seconds from clients 102 and 103, and may thus send synchronization instructions to client 101.

In the above example, the synchronization subsystem 120 is preferably aware of the availability of alternative streams and their (general) output timing. This may be the case if the synchronization subsystem 120 is co-located with a media server, or if the media server sends information about the availability and output timing to the synchronization subsystem 120. Also, in case of live content, the synchronization subsystem 120 may learn about the availability and output timing from reports of other clients. The synchronization subsystem 120 is preferably further aware of which streams offer the same content. Note that the instructions may also be general instructions to ‘switch’. A client, upon receiving these instructions, may know if alternative streams are available, and may then switch. This may lead to an improvement of the quality of sync, or it may not. This way, quality of sync may be improved in a trial-and-error manner.

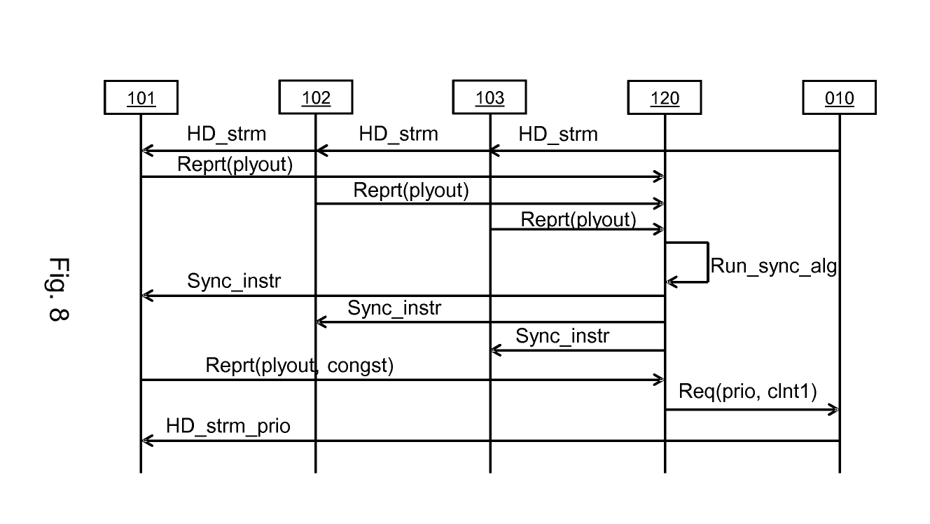

FIG. 8 illustrates another example of a corrective action, namely one involving an adjustment in priority in the streaming of the media stream. This example relates to more priority/more bandwidth being given to certain clients that experience more difficulties in synchronising. If a client has trouble keeping up, e.g., because of network congestion, that client may switch to a different media stream, but additionally or alternatively the network may also give more priority to the media stream for that client. This may address the network congestion problem in another manner. Such priority may also be pre-emptively given, in that clients for which a high level of syncness is desired may be given network priority before streaming commences.

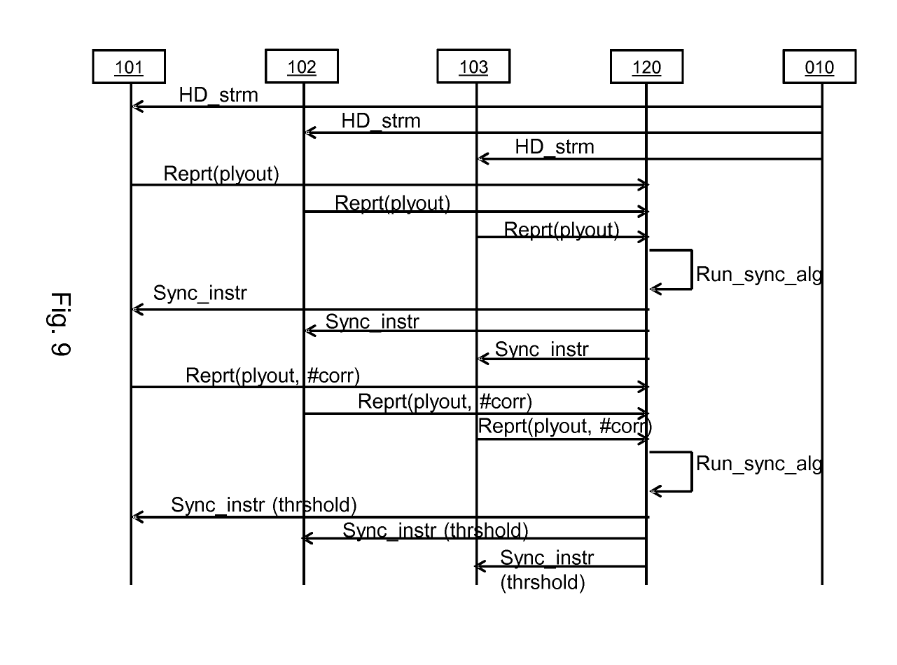

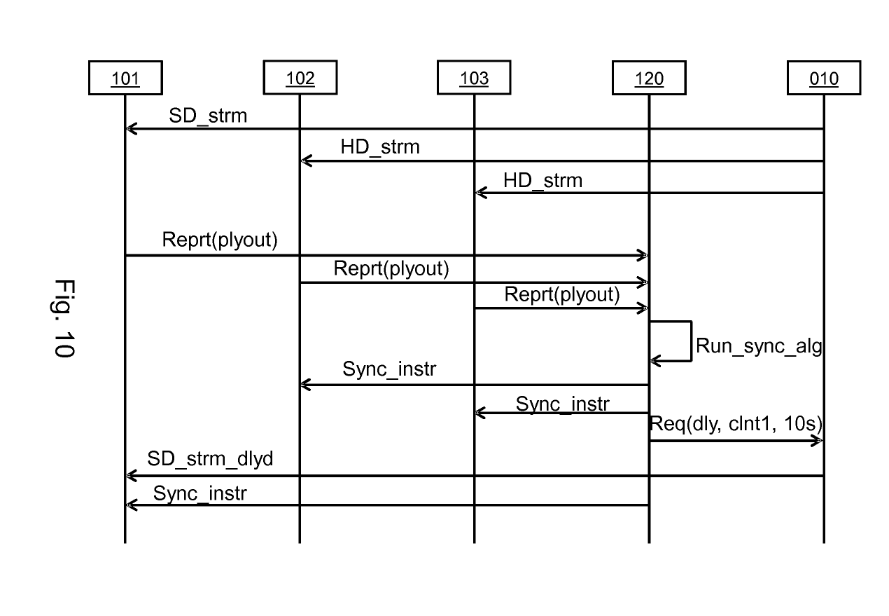

FIG. 8 shows an example data flow illustrating the above. In this example, as well as in the subsequent examples shown in FIGS. 9 and 10, the same entities are shown as in FIG. 7, namely clients 101-103, the synchronization subsystem 120 and the streaming source 010. Same labelled arrows represent same or similar actions.

As shown in FIG. 8, clients 101-103 may report about their play-out timing, and the synchronization server 120 may run its algorithm and send instructions to clients 101-103. Now, client 101 may be suffering from an additional delay compared to clients 102 and 103 in the play-out because of network congestion. Such congestion may be noticed by client 101 because of, e.g., packet loss and large round trip delays. Client 101 may report about this congestion to the synchronization subsystem 120 along with its new playing timing, as illustrated by the arrow titled “Reprt(plyout, congest)”, short for “Report(playout, congestion)”. The synchronization subsystem 120 may then request the stream source 010 to send the media stream to client 101 with a higher priority, e.g., by setting a DiffSery priority bit in the packets to a higher priority. This is illustrated by the arrow titled “Req(prio, cInt1)”, short for “Request(priority, client 1). The streaming source 010 may do so, and the client 101 may then receive the same HD stream but with less delay due to the higher priority being given to its delivery. This is illustrated by the arrow titled “HD_strm_prio”, short for “HD_stream_priority”.

Other examples of adjusting the priority or bandwidth of the delivery of the media stream may be the following. For example, in a managed network, a 3GPP (3rd Generation Partnership Project) PCC (Policy Control & Charging) or RACS (Resource & Admission Control Subsystem) architecture may be used to guarantee bandwidth for certain streams. The same may be accomplished using IntServ (Integrated services). Also, in the example of FIG. 8, the synchronization subsystem 120 requests the priority to be changed, but it may also be the client 101 itself that directly does this.

FIG. 9 illustrates another an example of a corrective action, namely one involving adjustment of a synchronization threshold. Clients usually have a certain (preconfigured) threshold when to synchronise. For example, only when the asynchrony goes above 0.2 seconds, the client may resynchronise. When a structural deficiency leads to an excessive number of resynchronization actions, it may be desirable to raise the threshold and rather accept a higher level of asynchrony. In a specific example, the threshold may be changed from a ‘unnoticeable threshold’ to an ‘acceptable threshold’, corresponding to respective synchronicity levels for lip-sync as shown in Appendix 1, FIG. 1.1 of the ITU T-REC-J.248-200806 recommendation. Or, if the chosen threshold leads to hardly any resynchronization actions, it may be desirable to lower the threshold to achieve an even higher level of synchrony.

FIG. 9 shows an example data flow illustrating the above. In this example, clients 101-103 receive a HD stream for which the play-out is to be synchronised, and they are all close to each other in delay. All clients 101-103 may report their play-out timing, and the synchronization subsystem 120 may send instructions to the clients for fine-scale synchronization. The clients 101-103 may then again report their play-out timing, but include the number of corrections they made in the meantime, as illustrated by respective arrows titled “Reprt(plyout, #corr)”, short for “Report(play-out, # corrections)”. In this example, client 101 may have made 5 corrections in the meantime, compared to 1 each for clients 102 and 103. As such, there may be a structural deficiency associated with client 101. For example, its clock may have excessive drift or its network connection may suffer from congestion. The synchronization subsystem 120 may now not only calculate new instructions, but also decide to change the threshold from 0.1 seconds to 0.3 seconds, as illustrated by respective arrows titled “Sync_instr(threshold)”, short for “Sync_instruction(threshold)”. As such, client 101 may have to perform synchronization actions less frequently, thereby increasing the quality of experience for its user during play-out.

Note that there may be different ways of adjusting a synchronization threshold. In the example of FIG. 9, the threshold may be implemented locally within a client. However, the threshold may also be implemented in the synchronization subsystem 120. In the latter case, the synchronization subsystem 120 may only send synchronization instructions to clients if they are more than a threshold apart. The threshold may then be raised internally to prevent too many synchronization actions.

FIG. 10 illustrates another example of a corrective action, namely one involving an adjustment in a timing of the delivery of the media stream. This corrective action may be considered as a form of source-controlled synchronization. Normally, synchronization may be achieved by buffering at the clients' side, or by controlling the media stream's output timing at the streaming source 010. When a synchronization system uses client-side buffering, and this may lead to significant buffering due to large delay differences between clients, it may be beneficial to have the source change its output timing to certain clients to reduce the buffering at the clients' side.

FIG. 10 shows an example data flow illustrating the above. In this example, client 101 is playing-out the media about 10 seconds before clients 102 and 103. This may be the case if, e.g., client 101 uses a different media stream than clients 102 and 103, e.g., a SD stream instead of a HD stream. The synchronization subsystem 120 may determine that client 101 is so far advanced compared to clients 102 and 103 based on the reports of the clients about their play-out timing. As such, the synchronization subsystem 120 may send synchronization instructions to clients 102 and 103 directly. Before sending synchronization instructions to client 101, the synchronization subsystem 120 may request the streaming source 010 to delay the streaming of the media stream to client 101 for 10 seconds, as illustrated by the arrow titled “Req(dely, cnIt1, 10 s”, short for “Request(delay, client1, 10 seconds)”. As such, the delivery of the SD stream to client 101 may be delayed by 10 seconds, as illustrated by the arrow titled “SD_strm_dlyd”, short for “SD_stream_delayed”. After this adjustment has been performed, e.g., the delivery delayed, the synchronization subsystem 120 may send the synchronization instructions to client 101.

It is noted that delaying the delivery of a media stream by 10 seconds typically constitutes a corrective action which is visible for client 101. As such, the performing of the corrective action may be weighed against other aspects of synchronization quality. In this case, the synchronization algorithm may determine that the additional delay for clients 102 and 103 may have a higher impact on the quality of synchronization than the delay action for client 101. It is also noted that it may be the streaming source 010 that performs the delay action, but it may also be another entity.

The present invention may have been described within the context of one or more media streams being streamed. However, such media streams may also be accessed by a play-out device in a non-streaming manner, e.g., from a file.

The following scenario exemplifies an advantageous use of the present invention. An overseas Dutch fan group may gather online to enjoy the 2016 Euro cup finale which opposes the Netherlands and the host country, France. The group may consist of 20 users that are logged into a streaming service. An IDMS cluster may then be created for these 20 users. Before the game starts, the users may be invited to switch on the video feed to start synchronized play-out among the group members. Because the fans are scattered all over the world the quality of synchronization of the various users may be quite different. It may turn out that there are too many resynchronization events that occur to keep the group in sync which ultimately leads to a poor quality of experience. As a result, the service may create two new clusters where clients with similar quality of sync metrics are migrated to. It will be appreciated that in general, quality of sync metrics as reported in the past may be used to preemptively schedule a corrective action. For example, if a certain client always had a fast connection, the client is likely to have one again during a current session. Such historical data may be updated with new measurements during the session. It is noted that the present invention is applicable to various forms of media synchronization, such as to, e.g., for inter-media synchronization in an HbbTV setting. An example is synchronizing an auxiliary stream delivered over the internet containing a sign language interpreter with a main stream representing a regular TV broadcast.

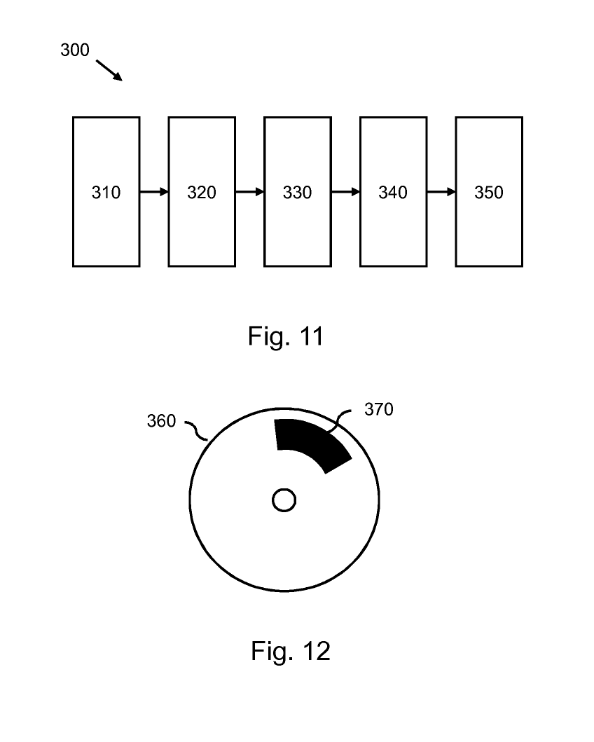

FIG. 11 shows a method 300 for media synchronization in a system comprising a play-out device for play-out of a media stream, wherein the play-out of the media stream by the play-out device is synchronized with a reference play-out, thereby obtaining a degree of synchronicity with the reference play-out. The method 300 may comprise, in the play-out device, determining 310 a quality of sync metric during the play-out of the media stream, the quality of sync metric being indicative of a structural deficiency in the obtaining of the synchronicity with the reference play-out, and externally reporting 320 the quality of sync metric. The method 300 may further comprise, in a metric system, receiving 330 the quality of sync metric from the play-out device, analysing 340 the quality of sync metric to identify the structural deficiency, and scheduling 350 a corrective action to address the structural deficiency.

It will be appreciated that a method according to the invention may be implemented in the form of a computer program which comprises instructions for causing a processor system to perform the method. The method may also be implemented in dedicated hardware, or as a combination of the above.

The computer program may be stored in a non-transitory manner on a computer readable medium. Said non-transitory storing may comprise providing a series of machine readable physical marks and/or a series of elements having different electrical, e.g., magnetic, or optical properties or values. FIG. 12 shows a computer program product comprising the computer readable medium 360 and the computer program 370 stored thereon. Examples of computer program products include memory devices, optical storage devices, integrated circuits, servers, online software, etc.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for media synchronization, comprising:
a play-out device for play-out of a media stream;
a synchronization subsystem for synchronizing the play-out of the media stream by the play-out device with a reference play-out, thereby obtaining a degree of synchronicity with the reference play-out;
wherein the play-out device comprises:
a quality of sync subsystem for determining a quality of sync metric during the play-out of the media stream, the quality of sync metric being indicative of a structural deficiency in the obtaining of the synchronicity with the reference play-out;
a reporting subsystem for externally reporting the quality of sync metric;
the system further comprising:
a metric subsystem for i) receiving the quality of sync metric from the play-out device, ii) analysing the quality of sync metric to identify the structural deficiency, and iii) scheduling a corrective action to address the structural deficiency.

2. The system according to claim 1, wherein the play-out device is configured for determining the quality of sync metric based on:
an occurrence of one or more playback operations performed by the play-out device during play-out of the media stream; and/or
a numerical measure of the degree of synchronicity obtained by the play-out device with the reference play-out.

3. The system according to claim 2, wherein the one or more playback operations comprise at least one of:
a pausing of the play-out, a stopping of the play-out,
a resuming of the play-out, a starting of the play-out,
a seeking in the media stream,
a change in speed of the play-out,
a frame drop during the play-out, and
a representation switch of the media stream in adaptive streaming.

4. The system according to claim 2, wherein the play-out device is configured for i) when performing the playback operation, registering a reason for performing the playback operation, thereby obtaining a registered reason, and ii) determining the quality of sync metric further based on the registered reason.

5. The system according to claim 11, wherein the play-out device is configured for formatting the quality of sync metric to indicate at least one of:
a time period to which the quality of sync metric pertains,
a number of occurrences of a type of playback operation, and
a difference, or a mean and a variance of the difference, between a current playback timestamp of the play-out device and a reference playback timestamp provided by the synchronization subsystem.

6. The system according to claim 1, wherein the play-out device is part of one or more play-out devices for play-out of the media stream, and wherein the corrective action is an adjustment in at least one of:
delivery of the media stream to at least one of the one or more play-out devices, and
a boundary condition associated with the synchronizing of the play-out of the media stream by the play-out device with the reference play-out.

7. The system according to claim 6, wherein the adjustment in the delivery of the media stream comprises at least one of:
a switching to a different media stream and/or to a different stream source for the same media stream, for at least one of the one or more play-out devices;
an adjustment in priority and/or bandwidth in the streaming of the media stream to at least one of the one or more play-out devices; and
an adjustment in a timing of the delivery of the media stream to at least one of the one or more play-out devices.

8. The system according to claim 6, wherein the adjustment in the boundary condition comprises at least one of:
a clustering or re-clustering of play-out devices in two or more clusters to which the media synchronization is separately applied to obtain a more homogenous quality of sync than would have been obtained when applying the media synchronization to a single cluster comprising all of the play-out devices;
an adjustment of the synchronization threshold in at least one of the one or more play-out devices, the synchronization threshold defining an allowed level of asynchrony between the play-out of the media stream and the reference play-out before a synchronization action is performed by a respective play-out device.

9. The system according to claim 1, wherein the metric subsystem is configured for effecting the corrective action by sending an instruction indicative of the adjustment to be performed to at least one of: at least one of the one or more play-out devices, a stream source providing the media stream, the synchronization subsystem, and a network entity involved in the streaming of the media stream to at least one of the one or more play-out devices.

10. The system according to claim 1, wherein the metric subsystem is configured for scheduling the corrective action in response to the quality of sync metric falling below a predetermined quality threshold.

11. The system according to claim 1, wherein communication between the play-out device and the metric subsystem takes place in accordance with a client-server communication scheme, and wherein the play-out device represents the client and the metric subsystem represents the server in the client-server communication scheme.

12. Play-out device for play-out of a media stream, the play-out of the media stream by the play-out device being synchronized by a synchronization subsystem with a reference play-out, thereby obtaining a degree of synchronicity with the reference play-out, the play-out device comprising:
a quality of sync subsystem for determining a quality of sync metric during the play-out of the media stream, the quality of sync metric being indicative of a structural deficiency in the obtaining of the synchronicity with the reference play-out;
a reporting subsystem for externally reporting the quality of sync metric.

13. Data representing the quality of sync metric reported by the play-out device as defined in claim 1.

14. A method for media synchronization in a system comprising a play-out device for play-out of a media stream, wherein the play-out of the media stream by the play-out device is synchronized with a reference play-out, thereby obtaining a degree of synchronicity with the reference play-out, the method comprising,
in the play-out device:
determining a quality of sync metric during the play-out of the media stream, the quality of sync metric being indicative of a structural deficiency in the obtaining of the synchronicity with the reference play-out;
externally reporting the quality of sync metric;
and in a metric system:
receiving the quality of sync metric from the play-out device,
analysing the quality of sync metric to identify the structural deficiency;
scheduling a corrective action to address the structural deficiency.

15. A computer program product comprising instructions for causing a processor system to perform the method according to claim 14.
